(19) United States
(12) Patent Application Publication
(10) Pub. No.: US 2024/0417181 A1
(43) Pub. Date: Dec. 19, 2024

(54) CONNECTING DEVICE AND CONVEYING ASSEMBLY HAVING A CONNECTING DEVICE

(71) Applicant: Bausch + Ströbel SE + Co. KG, Ilshofen (DE)

(72) Inventors: Matthias Ritz, Ilshofen (DE); Felix Schneiders, Ilshofen (DE); Martin Kaas, Ilshofen (DE); Axel Schmieg, Ilshofen (DE)

(21) Appl. No.: 18/817,386

(22) Filed: Aug. 28, 2024

Related U.S. Application Data
(63) Continuation of application No. PCT/EP2023/053557, filed on Feb. 14, 2023.

(30) Foreign Application Priority Data
Mar. 1, 2022 (DE) 10 2022 104 863.2

(51) Int. Cl. B65G 27/08; B65G 27/02

(52) U.S. Cl. CPC B65G 27/08; B65G 27/02

(57) ABSTRACT

A connecting apparatus connects a receiving body for conveyed goods to a base body. The apparatus includes an abutment device with a support element on the base body and an abutment element on the receiving body. When used, the receiving body rests on the support element via the abutment element. A locking device with a first locking element is rotatable about an axis of rotation relative to the base body. A second locking element is fixed to the receiving body. An actuating device is connected to the first locking element. The first locking element is transferrable from a release position, in which the locking elements are disengaged, into a locking position in which the locking elements engage one another. The first locking element is guided through a through-opening of the base body. A sealing element seals the through-opening. A conveying assembly can include the connecting apparatus.

### CROSS-REFERENCE TO RELATED APPLICATIONS

This application is a continuation application of international application number PCT/EP2023/053557, filed on Feb. 14, 2023, and claims the benefit of German application number 10 2022 104 863.2, filed on Mar. 1, 2022. The contents of international application number PCT/EP2023/053557 and German application number 10 2022 104 863.2 are incorporated herein by reference in their entireties.

### FIELD

The present disclosure relates to a connecting apparatus for connecting a receiving body for conveyed goods to a base body that can be excited into movement.

Furthermore, the present disclosure relates to a conveying assembly comprising a receiving body for conveyed goods, a base body, a drive device for the base body and a connecting apparatus.

### BACKGROUND

This type of conveying assembly is used, for example, in a machine for processing pharmaceutical packaging materials. The conveyed goods, for example closing elements in the form of stoppers for closing pharmaceutical containers, are received in the receiving body, which is designed for example as a conveying pot. By means of the drive device, the base body can, in particular, be excited into an oscillating movement. Via a connecting apparatus between the base body and the receiving body, the oscillation is transmitted to the receiving body in order to move the conveyed goods, which are conveyed out of the receiving body, for example, by a conveyor track in the form of a helix.

It is known to releasably connect the receiving body to the base body. This makes it possible, for example, to use different types of receiving bodies together with the same base body as required. Connecting devices configured as clamping devices are known, for example from DE 42 34 170 C2, DE 10 2009 018 932 B4 and DE 101 26 758 B4. Connecting devices using vacuum technology or electromagnets are also known.

Conventional conveyor assemblies having connecting apparatuses have the problem that connecting apparatuses have complicated structures that often comprise a plurality of components. These components can get lost, leading to malfunctions and contamination, and dirt can also accumulate on the components. Furthermore, conventional connecting apparatuses are known in which moving components are moved from a non-sterile region to a sterile region, which entails the risk of contamination when the connecting apparatuses are used in a pharmaceutical environment. Another disadvantage of the prior art is that connecting apparatuses can have openings, undercuts or concealed regions into which substances can penetrate, for example when cleaning the conveying assemblies. This makes cleaning more difficult, as the connecting apparatuses have to be covered or alternatively disassembled to remove any contaminants and/or cleaning residues. Failure to do so favors the entry of germs, with the risk that batches of pharmaceutical products may have to be completely or partially discarded if they become contaminated.

When processing pharmaceuticals containing toxic substances, vacuum-operated connecting apparatuses are not suitable because toxic substances could be sucked in. The problem with using electromagnetic connecting apparatuses is that the preferred pharmaceutical grade materials (e.g. 316 L stainless steel) cannot be used. Eddy currents also lead to undesirably high heating of the connecting apparatus.

An object underlying the present disclosure is to provide a connecting apparatus for connecting a receiving body to a base body, and a conveying assembly having a connecting apparatus that allows less dirt to be introduced than with conventional connecting apparatuses and conveying assemblies and preferably has better cleaning properties.

### SUMMARY

In a first aspect of the present disclosure, a connecting apparatus is provided for connecting a receiving body for conveyed goods to a base body that is able to be excited into movement. The connecting apparatus comprises an abutment device with at least one support element arranged on the base body and at least one corresponding abutment element arranged on the receiving body. In a state of use, the receiving body rests on the at least one support element of the base body via the at least one abutment element. The connecting apparatus further comprises a locking device with a first locking element is arranged on the base body and rotatable about an axis of rotation relative thereto, and a second locking element being fixed to the receiving body. The connecting apparatus further comprises an actuating device being operatively connected to the first locking element, wherein, by means of the actuating device the first locking element, by rotation about the axis of rotation, the first locking element is transferrable a release position, in which the locking elements are disengaged, into a locking position in which the locking elements are in clamping engagement with one another. The first locking element is guided through a through-opening of the base body and the connecting apparatus comprises a sealing element for sealing the through-opening.

In a second aspect of the present disclosure, a conveying assembly is provided. The conveying assembly comprises a receiving body for conveyed goods, a base body having a through-opening, a drive device for exciting an oscillating movement and/or translatory movement of the base body, and a connecting apparatus in accordance with the first aspect, via which the receiving body is preferably releasably connectable to the base body.

### BRIEF DESCRIPTION OF THE DRAWINGS

The foregoing summary and the following description may be better understood in conjunction with the drawing figures, of which:

FIG. 1 is a perspective representation, partially sectioned, of a conveying assembly in accordance with the present disclosure with a connecting apparatus in accordance with the present disclosure in an exploded view;

FIG. 2 is a partial representation of the conveying assembly with the connecting apparatus shown in FIG. 1, with some components hidden;

FIG. 3 is a plan view in axial direction along the arrow “3” in FIG. 2, showing the connecting apparatus and a base body of the conveying assembly;

FIG. 4 is a sectional view along the line 4-4 in FIG. 3 with an axially displaced locking element of the connecting apparatus; and

FIG. 5 is a representation corresponding to FIG. 4, wherein the sectional view along the line 5-5 in FIG. 3 is selected.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a connecting apparatus for connecting a receiving body for conveyed goods to a base body that is able to be excited into movement, comprising:
an abutment device with at least one support element arranged on the base body and at least one corresponding abutment element arranged on the receiving body, wherein, in a state of use, the receiving body rests on the at least one support element of the base body via the at least one abutment element,
a locking device with a first locking element arranged on the base body and rotatable about an axis of rotation relative thereto, and a second locking element fixed to the receiving body; and
an actuating device which is operatively connected to the first locking element, wherein by means of the actuating device the first locking element, by rotation about the axis of rotation, is transferrable from a release position, in which the locking elements are disengaged, into a locking position in which the locking elements are in clamping engagement with one another,
   wherein the first locking element is guided through a through-opening of the base body and the connecting apparatus comprises a sealing element for sealing the through-opening.

In the connecting apparatus in accordance with the present disclosure, the base body and the receiving body can be brought into contact with one another, in a preferably defined target position, during intended use. The at least one support element can rest on the at least one abutment element such that a movement can be transferred from the base body to the receiving body. The locking elements can be brought into engagement with one another in the locking position in such a way that the first locking element is held in a clamping manner by the second locking element. In particular, this makes it possible to subject the second locking element and thus the receiving body to a clamping force directed towards the base body. In this way, the receiving body can be reliably braced relative to the base body and held against it. Accordingly, the connecting apparatus forms a tensioning apparatus in particular. In simple terms with regard to the construction, the first locking element can be transferred from the release position into the locking position by rotation about the axis of rotation. Preferably, no further movement is required and/or provided for this, in particular no translatory movement. The actuating device, which is manually operable, for example, is provided for moving the first locking element. The first locking element, in a favorable manner, is guided through a through-opening on the base body that is sealed by means of the sealing element. This prevents the entry of contaminants from, for example, a non-sterile region on the side of the base body facing away from the receiving body. Conversely, the entry of substances from a sterile region into the non-sterile region is preferably avoided.

According to the above, the connecting apparatus in accordance with the present disclosure is particularly suitable for use with pharmaceutical packaging materials and, in this context, particularly also for WIP (washing in place) cleaning of the conveying assembly and/or when bottling toxic substances.

It is understood that the locking elements can be released from each other in particular in the release position in order to release the receiving body from the base body.

It is favorable if the first locking element, in order to transfer from the release position to the locking position and/or vice versa, is free from a lifting movement relative to the base body. In the present case, this can be understood to mean in particular that preferably no translatory movement is provided, for example along the axis of rotation. By eliminating the lifting movement, the entry of contaminants, for example from the non-sterile region into the sterile region, can be avoided.

It is advantageous if an front face of the base body facing the receiving body is planar. This improves the cleaning properties of the base body and reduces the likelihood of contaminants sticking thereto.

It can be advantageous if a front face of the base body facing the receiving body is free of through-openings, recesses and/or indentations. This reduces the likelihood of contaminants accumulating on the front face and, for example in the case of the through-openings, contaminants from the non-sterile region entering the sterile region. Preferably, the cleanability of the base body is improved by avoiding through-openings, recesses and/or indentations.

The base body is, for example, plate-shaped in portions and comprises a circumferential edge pointing away from the receiving body radially on the outside with respect to the axis of rotation. The edge protrudes, for example, from a plate-shaped portion that faces the receiving body. The edge encloses, for example, a receiving space that is formed on the base body on the side facing away from the receiving body. For example, the actuating device and/or a transmission device, via which the actuating device is coupled to the first locking element, can be arranged in the receiving space.

It can be advantageous if the locking elements can be brought into engagement with one another by means of an axial plug-in movement and subsequent rotary movement about the axis of rotation. For example, the locking elements can be brought into engagement with each other in the manner of a bayonet connection.

It may be provided, for example, that a recess is arranged on one locking element, into which recess the respective other locking element engages, in particular in a defined target position of the receiving body relative to the base body. It may be provided that the locking element can only engage in the recess in such a way that it can be transferred to the locking position when the release position is assumed. The locking element engaging in the recess engages behind, for example, the respective other locking element in the locking position of the first locking element, and rests against the latter.

The recess is arranged on the second locking element, for example, and the first locking element engages in the recess, although an inverted construction can also be provided.

The first locking element and/or the second locking element can, for example, comprise a sloping surface aligned at an angle to the axis of rotation in the manner of a “run-up slope” and couple with one another using this until one locking element engages behind the other locking element in a clamping manner for further actuation of the actuating device.

The aforementioned recess can, for example, be a through-opening on the locking element, through which the respective other locking element preferably engages in a positive-locking manner. For example, the through-opening is arranged on the second locking element and the first locking element engages through the through-opening.

When the receiving body is placed on the base body, for example, the first locking element is guided into the recess and, for example, through the through-opening and assumes the release position. The locking element can be moved into the locking position by means of the actuating device.

One of the locking elements, in particular the first locking element, is L-shaped or T-shaped, for example, with one or two locking portions(s) and an axially aligned shaft portion that is mounted on the base body so as to be indirectly or directly rotatable about the axis of rotation. The at least one locking portion can engage behind the other locking element in the locking position and rest against it. The shaft portion is used indirectly or directly for rotatable mounting on the base body.

A T-shaped locking element has, for example, a central shaft portion and radially extending locking portions in an axial plan view. The locking portions can be widened relative to the shaft portion in order to form a comparatively large contact surface for the additional locking element. In a plan view, the locking element can, for example, have the shape of a bow tie (garment), and the locking portions can be radially rounded on the outer side.

It is advantageous if the connecting apparatus comprises or forms an alignment device for aligning the receiving body relative to the base body in a defined target position. This facilitates the handling of the connecting apparatus and the conveying assembly.

In particular, it is advantageous if the alignment device is designed in such a way that only one unique target position of the receiving body relative to the base body is possible, with a view to particularly easy handling and reliable function.

Preferably, it can be provided that the abutment device comprises or forms the alignment device, wherein the at least one abutment element rests in a defined position on the at least one support element in the state of use. Additional alignment elements can be avoided in this way and the design of the connecting apparatus can be kept simple.

The at least one support element can, for example, comprise or form a recess centering the at least one abutment element, or vice versa. This allows, for example, self-centering of the support element and abutment element in relation to each other, for easier handling of the connecting apparatus. The recess is channel-shaped, for example, and tapers so that a strip-shaped element (e.g. the abutment element) can be centered in the channel.

In a preferred embodiment, the abutment device comprises two or more abutment elements and support elements, wherein, for example, three or more support elements and/or abutment elements can be provided that, with respect to an axial viewing direction, are arranged in particular at corner regions of an imaginary polygon. For example, the three support elements define a plane that coincides with a plane of the abutment elements. The support elements and the abutment elements can, for example, be arranged radially on the outside in relation to the axis of rotation in order to allow support at a distance from the axis of rotation.

In the latter advantageous embodiment in particular, it may be provided that the first locking element is positioned centrally in the imaginary polygon. In particular, the axis of rotation can run through the (geometric) center of the polygon.

It can be provided if the at least one support element projects beyond a front face of the base body facing the receiving body, in particular a planar front face, in the direction of the receiving body.

The at least one support element can, for example, be formed separately from the base body and connected thereto, wherein preferably a sealing element is arranged between the base body and the at least one support element. With regard to the cleanability of the connecting apparatus, accumulation of contaminants between the support element and the base body is preferably avoided by the sealing element. For example, the support element is connected to the base body by screwing, wherein it covers a through-opening on the base body and the sealing element is positioned between the support element and the base body in order to also seal the through-opening.

In another advantageous embodiment, it may be provided that the at least one support element is formed together with the base body, for example integrally.

For a structurally simple configuration, it is advantageous if the at least one abutment element, in particular the two or more abutment elements, are preferably integrally connected to the second locking element. A connecting part formed in this way, comprising the locking element and at least one abutment element, can, for example, be fixed or fixable to a bottom wall of the receiving body.

In an advantageous embodiment, the second locking element has, for example, a through-opening for the first locking element, at the edge of which contact portions for locking portions of the first locking element are arranged. The support elements can protrude radially from the locking element and are configured, for example, in the shape of a strip.

The actuating device is manually operable, for example. It can be advantageous if the actuating device comprises a handle element arranged outside the base body for an operator. In this way, the operator can easily access the handle element.

As an alternative or in addition to manual operation of the actuating device, an actuating device having an electric drive and/or pneumatic drive can be provided, for example.

The handle element is preferably coupled to a shaft element, is mounted in the base body so as to be rotatable about a shaft axis, and, in turn, is operatively connected to the first locking element.

It can be provided, for example, that the shaft element is aligned eccentrically with respect to the axis of rotation. Alternatively or additionally, the shaft element is arranged, for example, in a plane aligned perpendicular to the axis of rotation. For example, a skewed alignment of the axis of rotation and the shaft axis is conceivable.

It can prove to be advantageous if the connecting apparatus comprises a transmission device via which the actuating device is operatively connected to the first locking element.

In a preferred embodiment, the transmission device is or comprises a worm gear. The worm gear preferably comprises a gear wheel connected in a rotationally fixed manner to the first locking element and a worm element, on the actuating device, which is in engagement with the gear wheel. For example, the worm element is arranged on the aforementioned shaft element and meshes with the gear wheel, which is rotatably mounted on the base body, when the shaft element rotates. A relatively compact design of the connecting apparatus and the conveying assembly can be achieved using the worm gear. The locking elements can be reliably clamped together with little effort on the part of the operator.

For the purpose of a compact design and/or for protection, the transmission device can, for example, be arranged on a side of the base body facing away from the receiving body and be enclosed in the circumferential direction of the axis of rotation by an edge of the base body pointing away from the receiving body.

It is understood that mounting elements are preferably provided for mounting movable components. These are preferably plain abutment elements for the first locking element, the transmission device or its components and/or the actuating device on the base body.

It is advantageous if the connecting apparatus comprises or forms a torque limiting device for limiting a torque exerted or exertable on the first locking element by means of the actuating device. In this way, excessive force between the locking elements can be avoided and the connecting apparatus can be protected from damage. At the same time, there is the possibility of a defined clamping force with a view to reliably fixing the receiving body to the base body.

The actuating device comprises, for example, the torque limiting device.

The torque limiting device can be interchangeable so that different maximum torques can be set, with a view to versatile use of the connecting apparatus.

In a preferred structural configuration, the handle element and the shaft element are connected to one another via the torque limiting device, wherein the latter is arranged, for example, axially with respect to the shaft axis between the shaft element and the handle element.

It can be provided that a stop element and a corresponding stop element are provided on the base body on the first locking element or in a rotationally fixed connection with the first locking element, by means of which a range of movement of the first locking element is predetermined during rotation relative to the base body. For example, the stop elements couple to each other in a first position when the first locking element assumes the release position. This allows the user to ascertain that the receiving body has been released and can be lifted from the base body. A second stop is provided, for example, as an end stop for the rotation of the first locking element. The first locking element assumes the locking position before reaching the end stop, for example. The angle of rotation about the axis of rotation before reaching the end stop is determined, for example, by the torque limiting device.

In terms of construction, the stop elements can be easily formed, for example, by a receptacle and a projection that engages therein. The receptacle, for example in the form of a groove, can be arranged on the base body and the projection on the transmission device, or vice versa.

Preferably, the connecting apparatus is free of vacuum actuation, magnetic and/or electrical fixation.

As mentioned at the outset, the present disclosure also relates to a conveying assembly.

A conveying assembly for conveying conveyed goods in accordance with the present disclosure, which achieves the object mentioned at the outset, comprises a receiving body for conveyed goods, a base body having a through-opening, a drive device for exciting an oscillating movement and/or translatory movement of the base body, and a connecting apparatus of the type described above, via which the receiving body is preferably releasably connectable to the base body.

The advantages already mentioned in connection with the explanation of the connecting apparatus in accordance with the present disclosure can also be achieved with the conveying assembly. In this regard, reference can be made to the above statements.

Advantageous embodiments of the conveying assembly in accordance with the present disclosure result from advantageous embodiments of the connecting apparatus in accordance with the present disclosure. In this respect, reference is made to the above statements.

The drive device can, for example, be configured to function in a conventional electromagnetic manner to excite the oscillation of the base body. A restoring force can, for example, be exerted on the base body by means of spring elements known per se. As mentioned above, the use of a worm gear for the transmission device is advantageous in order to achieve a compact design in the axial direction, wherein, for example, the drive device and/or the spring elements can be positioned laterally next to the centrally arranged worm gear in the axial direction of view.

The receiving body is, for example, a conveying pot with a bottom wall and a casing, on the inside of which a rising helix for the conveyed goods is arranged.

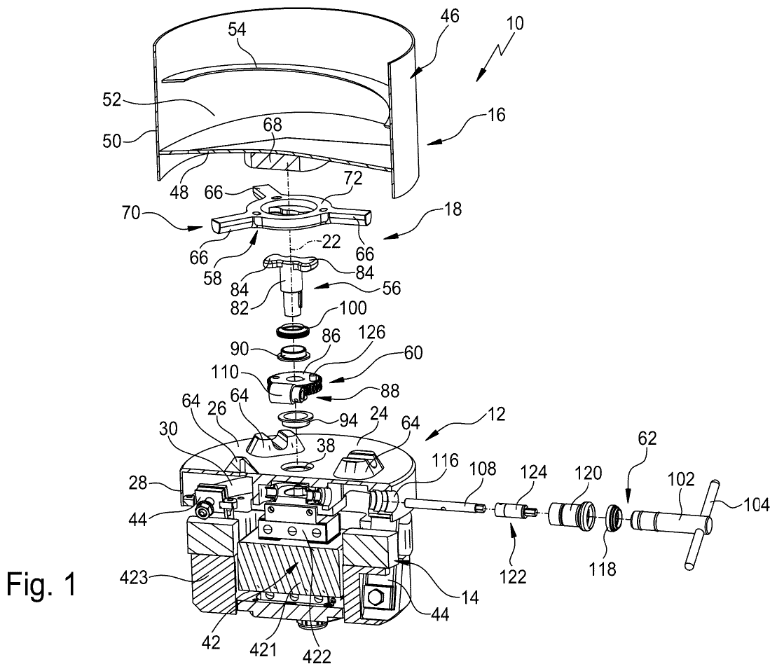

FIG. 1 is an exploded perspective representation, partially sectioned, of a generally advantageous embodiment of the conveying assembly in accordance with the present disclosure, denoted overall by the reference numeral 10. The conveying assembly 10 comprises a base body 12, a drive device 14 for driving the base body 12 and a receiving body 16.

To connect the receiving body 16 to the base body 12, a preferred embodiment of the connecting apparatus 18 in accordance with the present disclosure is provided, the components of which are arranged on the base body 12 and on the receiving body 16 as explained below.

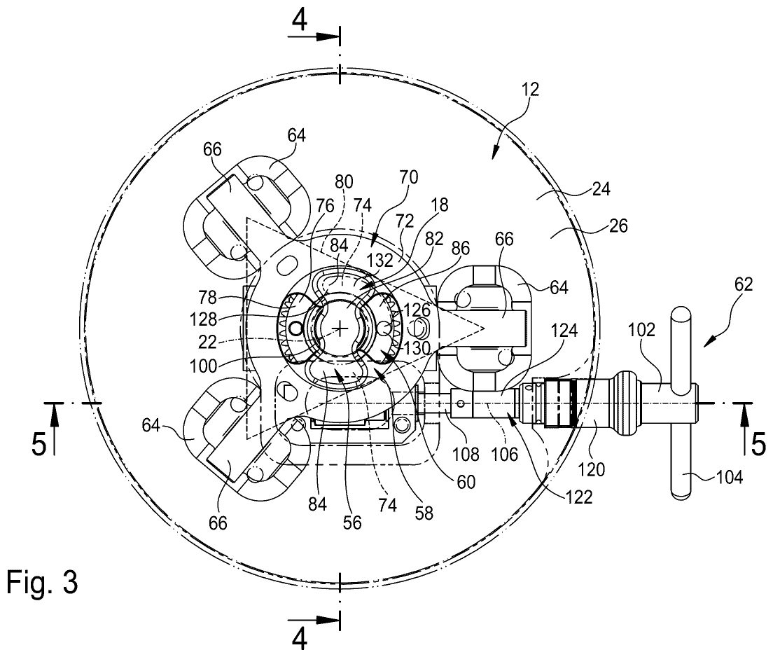

In the present example, the base body 12 is disk-shaped with a substantially circular contour in plan view (FIG. 3). The base body 12 defines an axis 22, hereinafter referred to as the axis of rotation 22. The base body 12 comprises a plate-shaped portion 24 having a front face 26 facing the receiving body 16 when the conveying assembly 10 is used as intended.

An edge 28 extends from the plate-shaped portion 24 in the direction pointing away from the receiving body 16 in the circumferential direction of the axis of rotation 22. The edge 28 encloses a receiving space 30, which is bounded at the top, facing the receiving body 16, by the plate-shaped portion 24. A receiving portion having an edge 34 and a mounting region 36, which will be discussed below, protrudes centrally from the plate-shaped portion 24 in the receiving space 30.

A through-opening 38 is formed centrally on the base body 12.

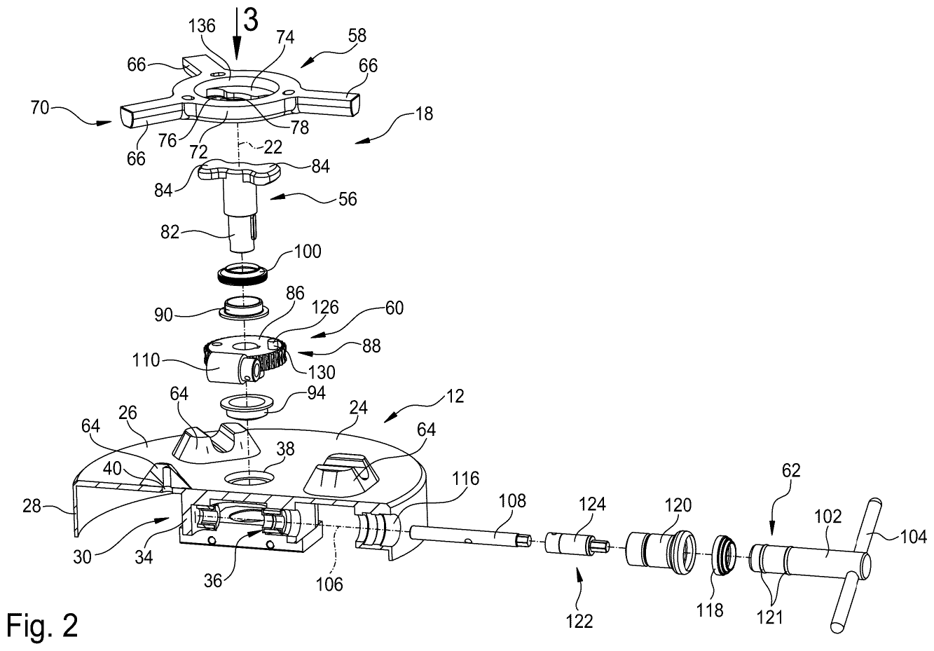

In addition, at least one further through-opening 40 is formed on the base body 12, for example. Of these, FIGS. 1, 2 and 5 each show a through-opening 40 for passing a connecting element through in order to fix a support element to the base body 12 as explained below.

Apart from the through-openings 38, 40, the base body 12 has no other through-openings in the direction of the receiving body 16. At the front face 26, the plate-shaped portion 24 is planar and also free of indentations or recesses.

The drive device 14 serves to excite the base body 12 into a movement, in particular an oscillating movement in the present case. For this purpose, the drive unit 14 is functionally designed as follows, for example.

The drive device 14 comprises at least one electromagnetic actuator 42, shown schematically in the drawing, with a magnet 421 and an armature 422 for exerting a force as a result of which the base body 12 is made to oscillate. 423 denotes a base body that is provided as an inertial mass against the excitation.

At least one restoring element is preferably provided, which applies a corresponding restoring force and is designed in the present case as a spring element 44, for example as a leaf spring.

The drive device 14 is arranged on the side facing away from the receiving body 16 and positioned within the contour defined by the edge 28. A housing not shown in the drawing can be provided, with which the drive device 14 is covered in the circumferential direction of the axis of rotation 22 and at the bottom. The housing is pot-shaped, for example, and comprises a casing that is connected to the base body 12, for example at the edge 28, preferably in a sealing manner.

The receiving body 16 is configured in this case as a conveyor bowl 46 and is used to receive conveyed goods not shown in the drawing. For example, the conveying assembly 10 is used in a machine for processing pharmaceutical packaging materials, wherein closing elements such as stoppers for closing pharmaceutical containers are stored as conveyed goods.

The conveying assembly 10 can, in particular, form a so-called “oscillating conveyor” for this purpose. In particular, the base body can form a so-called “oscillating plate”.

The conveyor bowl 46 comprises a bottom wall 48 and a circumferential casing 50 that forms the side wall of the conveyor bowl 46. The conveyed goods are accommodated in a receiving space 52 enclosed by the casing 50 and the bottom wall 48. A rising helix 54 is arranged on the inside of the casing 50.

As a result of the oscillation of the base body 12, the receiving body 16 connected via the connecting apparatus 18 is also made to oscillate. The conveyed goods are conveyed upwards via the rising helix 54 and fed to the intended processing.

It is understood that position and orientation indications such as “top,” “bottom,” “above,” “below” or the like are to be understood in relation to an intended state of use of the conveying assembly 10. In the state of use, the receiving body 16 is placed on the base body 12 from above, in relation to the direction of gravity.

Orientation or directional indications such as “axial” or “radial” refer to the axis of rotation 22 in the present case, unless otherwise explained.

The connecting apparatus 18 comprises a first locking element 56, a second locking element 58, a transmission device 60, an actuating device 62, at least one support element, in the present case three support elements 64 and at least one abutment element in a number corresponding to the at least one support element 64, in the present case three abutment elements 66.

The second locking element 58 is fixed in the present case to the receiving body 16, for example by screwing. For this purpose, a projection 68 arranged on the bottom wall 48 is provided on the receiving body 16, and projects in the direction of the base body 12.

In the present preferred embodiment, the connecting apparatus 18 has a connecting part 70 that comprises the second locking element 58 and the abutment elements 66. The connecting part 70 is preferably formed integrally, so that in particular an integral connection of the abutment elements 66 to the second locking element 58 is provided.

It is understood that the abutment elements 66 could be formed separately from the second locking element 58.

As can be seen in particular from FIGS. 1 to 3, the locking element 58 in the present example has a ring portion 72 preferably aligned coaxially with the axis of rotation 22. Radially on the inside, two contact portions 74 protrude from the ring portion 72 and each form the edge of a recess 76. In the present case, the recess 76 is formed as a through-opening 78 of the locking element 58, the contour of which is emphasized in FIG. 3 with a thicker line.

In axial plan view, the through-opening 78 has a central, substantially circular contour having a constriction from which the recess 76 widens on opposite sides, so that the through-opening 78 has a contour similar to a bow tie (garment) in plan view.

In the present case, the abutment elements 66 are formed in the shape of a strip. The abutment elements 66 protrude from the ring portion 72 in a radial direction.

As in the present exemplary embodiment, it is favorable if the angular distances of the abutment elements 66 from one another are different. In the present case, the abutment elements are arranged at corner regions of an imaginary polygon, namely an imaginary triangle, in relation to the axial viewing direction, wherein this triangle is an isosceles triangle. The reference numeral 80 in FIG. 3 schematically represents the contour of the triangle.

Two of the abutment elements 66 have an angular spacing with respect to the axis of rotation 22 of substantially 100 degrees (the two abutment elements 66 shown on the left in FIG. 3). The respective angular distance to the third abutment element 66 (illustrated on the right in FIG. 3) is substantially 130 degrees.

The support elements 64 are positioned so as to correspond to the abutment elements 66, wherein each support element 64 cooperates with a abutment element 66. As can be seen in particular from FIGS. 1 to 3, three support elements 64 are arranged at corner regions of the polygon (triangle) imagined in axial plan view. In this case, too, different angular distances are provided with respect to the axis of rotation 22, wherein two support elements 64 have an angular distance of substantially 100 degrees from one another and the angular distance to the respective third support element 64 is substantially 130 degrees.

It is understood that different angular spacings and/or a different number of support elements 64 and/or abutment elements 66 could be provided.

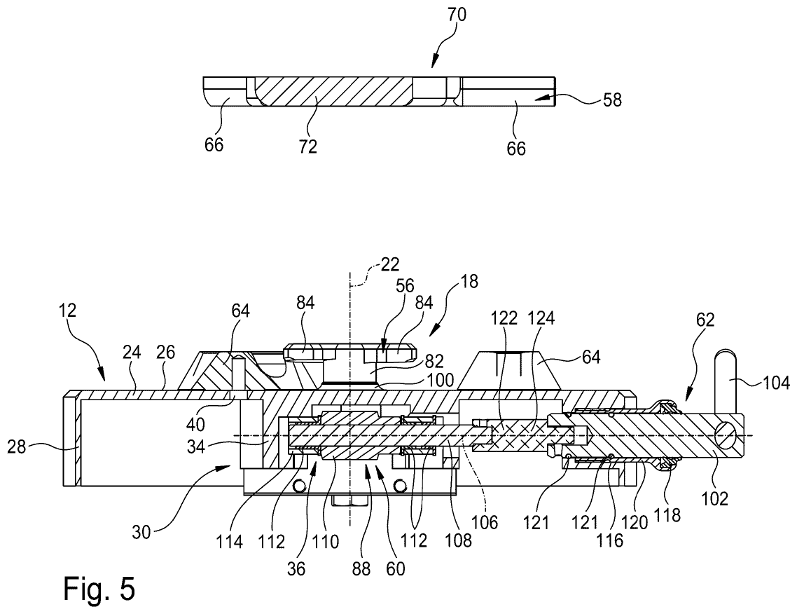

The support elements 64 protrude from the front face 26 in the direction of the receiving body 16. The support elements 64 are formed separately from the base body 12 in this case, wherein the connection is made, for example, by screwing through the through-openings 40 (FIG. 5).

A sealing element, which is not shown separately in the drawing, is arranged between the base body 12 at its front face 26 and the respective support element 64 in order to achieve a seal in this region and in particular also in the through-opening 40. This can prevent contaminants from entering between the support element 64 and the base body 12.

In a different embodiment, the base body 12 can be manufactured integrally with the support element(s).

In the state of use, the receiving body 16 can rest on the support elements 64 and thus on the base body 12 via the abutment elements 66. In this case, the receiving body 16 and the base body 12 assume a defined target position. In particular, a unique relative orientation of the receiving body 16 and the base body 12 is ensured.

In the defined target position, the receiving body 16 and the second locking element 58 are aligned coaxially with the base body 12 and the first locking element 56, the configuration of which is described below.

In the present example, the first locking element 56 is substantially T-shaped and comprises a central, axially extending shaft portion 82. At least one locking portion 84 protrudes radially from the shaft portion 82. In the present case, two locking portions 84 are provided opposite one another with respect to the shaft portion 82. The locking portions 84 are arranged on the end side of the shaft portion 82, facing the second locking element 58.

In axial plan view, the first locking element 56 has a substantially circular contour on the shaft portion 82. The locking portions 84 follow a constriction and widen in the radial direction and are radially rounded on the outer side.

The shape of the first locking element 56 with the shaft portion 82 and the locking portions 84 corresponds to the contour of the through-opening 78 on the second locking element 58. In particular, the locking element 58 can be guided through the through-opening 78 in a positive-locking manner.

The actuating device 62 is operatively connected to the first locking element 56 and serves to transfer the latter from a release position to a locking position and vice versa. In the release position, the receiving body 16 can be released from the base body 12. In the locking position, the locking elements 56, 58 are in clamping engagement with one another.

The actuating device 62 is coupled to the first locking element 56 via the transmission device 60.

The locking element 56 is, as can be seen in the present case in particular from FIGS. 1, 2 and 4, connected in a rotationally fixed manner to a gear wheel 86 of the transmission device 60. In the present case, the gear wheel 86 is a toothed wheel of a worm gear 88, which is how the transmission device 60 is configured.

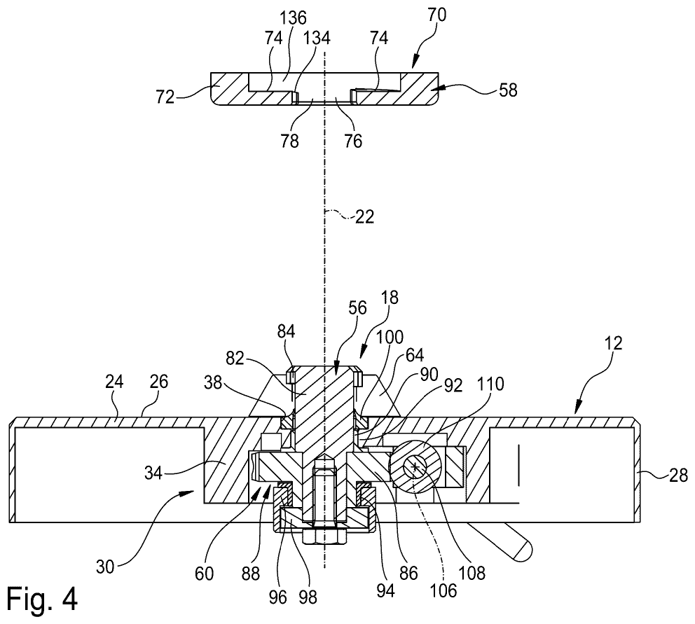

The gear wheel 86 is mounted axially and radially on the base body 12 via a mounting device. For this purpose, the mounting device comprises a mounting element 90 that surrounds the shaft portion 82 and rests against the gear wheel 86. The mounting element 90 rests against a step 92 of the base body 12 (FIG. 4).

A further mounting element 94 is arranged axially on the opposite side, and surrounds the gear wheel 86 and supports it axially and radially relative to a connecting part 96. The connecting part 96 is connected to the downwardly projecting edge 34 of the base body 12 and in the present example serves as a counter-holder for a support part 98, via which in the present example the shaft portion 82 is supported at the bottom and held, for example by screwing (FIG. 4).

The mounting elements 90, 94 are, in particular, plain bearing elements.

A sealing element 100 surrounds the shaft portion 82 and is arranged in the through-opening 38 to seal it.

The sealing element 100 ensures that no contaminants from the non-sterile region below the base body 12 enter the sterile region outside when used in a pharmaceutical environment. Conversely, the entry of contaminants from above through the through-opening 38 is prevented. Therefore, the connecting apparatus 18 in accordance with the present disclosure and the conveying assembly 10 in accordance with the present disclosure are in particular also suitable for WIP applications and/or for use in processing machines for toxic substances. This is all the more the case as no freely accessible openings are provided on the base body 12.

In the present case, the actuating device 62 is manually operable. It comprises a handle element 102 that is arranged outside the base body 12 for an operator and comprises or forms, for example, a toggle 104.

As an alternative or in addition to manual operation of the actuating device, an actuating device having an electric drive and/or pneumatic drive can be provided, for example.

The handle element 102 is connected to a shaft element 108 of the actuating device 62 defining a shaft axis 106.

A worm element 110 of the worm gear 88 is arranged on the shaft element 108. The worm element 110 meshes with the gear wheel 86, so that when the handle element 102 rotates about the shaft axis 106, the first locking element 56 rotates about the axis of rotation 22.

The shaft element 108 is rotatably mounted on a support part 114 via mounting elements 112, which are designed as plain bearings in the present case, and which is connected to the base body 12 in the position region 36 (FIG. 5).

In the present case, the shaft axis 106 is arranged eccentrically with respect to the axis of rotation 22 and, in particular, lies in a plane that is aligned perpendicular to the axis of rotation 22. The axis of rotation 22 and the shaft axis 106 are positioned skew to one another.

The handle element 102 extends through a through-opening 116 at the edge 28. At least one sealing element 118 seals directly or indirectly between the through-opening 116 and the handle element 102. In the present case, the sealing element 118 is annular and seals the handle element 102 relative to a sleeve 120 surrounding the handle element, which sleeve is inserted into the through-opening 116 and serves as a guide sleeve.

The sealing element 118 thus also achieves sealing of the base body 12 in the region of the actuating device 62, so that the conveying assembly is preferably sealed on all sides.

O-rings 121 surround the handle element 102 and serve for guidance and/or sealing relative to the sleeve 120 and relative to the edge of the through-opening 116.

The connecting apparatus 18 further comprises a torque limiting device 122 for limiting a torque exertable on the first locking element 56 via the handle element 102. In the present case, the torque limiting device 122 is formed by a torque adapter 124 arranged between the handle element 102 and the shaft element 108. In addition to limiting the torque, it is also ensured that a suitable torque is applied with a view to reliable connection of the locking elements 56, 58.

In the present case, the range of movement of the first locking element 56 relative to the base body 12 is predetermined by corresponding stop elements 126, 128 (FIG. 3). The stop element 126 is a projection 130, for example in the form of a pin, on the gear wheel 86. The stop element 128 is, for example, a groove-shaped track 132 on the base body 12 having end boundaries, into which track 132 the projection 130 engages.

The track 132 extends over an angular range of substantially 100 degrees with respect to the axis of rotation 22. Accordingly, the first locking element 56 can be rotated over a maximum angular range of substantially 100 degrees. The clamping engagement between the locking elements 56, 58, on the other hand, starts in particular earlier with the locking position, for example after 90°. In this way, a maximum overlap between the contact portions 74 and the locking portions 84 can preferably be achieved.

In the intended use of the conveying assembly 10, for example, the following procedure can be followed:

Using the handle element 102, the operator turns the locking element 56, if not already engaged, into the release position. This is made easier for the operator by the stop of the projection 130 at the end of the track 132. In the release position, the first locking element 56 assumes the position shown in FIGS. 1, 2, 4 and 5.

The receiving body 16 is placed on the base body 12. The unique position is ensured by the abutment elements 66 and the support elements 64.

Only in the defined target position and when the first locking element 56 assumes the release position can said first locking element be guided through the through-opening 78.

By rotating the handle element 102 about the shaft axis 106, the first locking element 56 is rotated about the axis of rotation 22 and transferred to the locking position shown in FIG. 3.

In the locking position, the locking portions 84 rest against the contact portions 74. At the same time, the second locking element 58 is in this way subjected to a clamping force acting in the direction of the base body 12.

The rotation of the first locking element 56 is facilitated by the fact that the contact portions 74 have sloping surfaces 134 inclined relative to the axis of rotation 22 as a “run-up slope” (FIG. 4).

In the locking position, the first locking element 56 engages behind the second locking element 58 and is arranged in the region of a stepped cutout 136 formed between the projection 68 and the contact portions 74.

The clamping force with which the locking elements 56, 58 interact can be limited by means of the torque adapter 124.

During operation, the oscillation transmitted from the actuator 42 to the base body 12 is transmitted to the receiving body 16, in particular via the support elements 64 and the abutment elements 66.

To release the receiving body 16 from the base body 12, the procedure can be reversed. By rotating the handle element 102 in the opposite direction, the locking elements 56, 58 are disengaged as a result of the locking element 56 rotating about the axis of rotation 22 and being transferred from the locking position to the release position. In the release position, the locking element 56 is aligned with the through-opening 78, so that the receiving body 16 can be lifted from the base body 12.

### LIST OF REFERENCE NUMERALS

10 Conveying assembly
12 Base body
14 Drive device
16 Receiving body
18 Connecting apparatus
22 Axis of rotation
24 Plate-shaped portion
26 Front face
28 Edge
30 Receiving space
34 Edge
36 Mounting region
38 Through-opening
40 Through-opening
42 Actuator
421 Magnet
422 Armature
423 Base body
44 Spring element
46 Conveying pot
48 Bottom wall
50 Casing
52 Receiving space
54 Rising helix
56 First locking element
58 Second locking element
60 Transmission device
62 Actuating device
64 Support element
66 Abutment element
68 Projection
70 Connecting part
72 Ring portion
74 Contact portion
76 Recess
78 Through-opening
80 Contour
82 Shaft portion
84 Locking portion
86 Gear wheel
88 Worm gear
90 Mounting element
92 Step
94 Mounting element
96 Connecting part
98 Support part
100 Sealing element
102 Handle element
104 Toggle
106 Shaft axis
108 Shaft element
110 Worm element
112 Mounting element
114 Support part
116 Through-opening
118 Sealing element
120 Sleeve
121 O-ring
122 Torque limiting device
124 Torque adapter
126 Stop element
128 Stop element
130 Projection
132 Track
134 Sloping surface
136 Cutout

1. A connecting apparatus for connecting a receiving body for conveyed goods to a base body that is able to be excited into movement, the connecting apparatus comprising:
an abutment device with at least one support element arranged on the base body and at least one abutment element arranged on the receiving body, wherein, in a state of use, the receiving body rests on the at least one support element of the base body via the at least one abutment element;
a locking device with a first locking element arranged on the base body and rotatable about an axis of rotation relative thereto, and a second locking element fixed to the receiving body; and
an actuating device which is operatively connected to the first locking element, wherein by means of the actuating device the first locking element, by rotation about the axis of rotation, is transferrable from a release position, in which the first and second locking elements are disengaged, into a locking position in which the first locking element and the second locking element are in clamping engagement with one another,
the first locking element being guided through a through-opening of the base body and the connecting apparatus comprises a sealing element for sealing the through-opening.

2. The connecting apparatus according to claim 1, wherein the first locking element, in order to transfer from the release position to the locking position and/or vice versa, is free from a lifting movement relative to the base body.

3. The connecting apparatus according to claim 1, wherein a front face of the base body facing the receiving body is planar and/or free of through-openings, recesses and/or indentations.

4. The connecting apparatus according to claim 1, wherein the base body is configured to be plate-shaped and comprises a circumferential edge pointing away from the receiving body radially on an outside with respect to the axis of rotation.

5. The connecting apparatus according to claim 1, wherein the first locking element and the second locking element are able to be brought into engagement with one another by means of an axial plug-in movement and subsequent rotary movement about the axis of rotation.

6. The connecting apparatus according to claim 1, wherein a recess is arranged on one of the first and second locking elements, into which recess the other of the first and second locking elements engages in a defined target position of the receiving body relative to the base body.

7. The connecting apparatus according to claim 6, wherein said other of the first and second locking elements engages behind said one of the first and second locking elements in the locking position and rests against said one of the first and second locking elements.

8. The connecting apparatus according to claim 6, wherein the recess is a through-opening on said one of the first and second locking elements, through which said other of the first and second locking elements engages in a positive-locking manner.

9. The connecting apparatus according to claim 1, wherein one of the first and second locking elements is configured to be L-shaped or T-shaped with one or two locking portion(s) and an axially aligned shaft portion that is mounted on the base body so as to be indirectly or directly rotatable about the axis of rotation.

10. The connecting apparatus according to claim 1, wherein the connecting apparatus comprises or forms an alignment device for aligning the receiving body relative to the base body in a defined target position, wherein the abutment device comprises or forms the alignment device, wherein the at least one abutment element rests in a defined position on the at least one support element in the state of use.

11. The connecting apparatus according to claim 10, wherein the alignment device is designed such that only one target position of the receiving body relative to the base body is possible.

12. The connecting apparatus according to claim 1, wherein the abutment device comprises three or more support elements and/or abutment elements that, with respect to an axial viewing direction, are arranged at corner regions of an imaginary polygon having a center, the corner regions being arranged radially outside with respect to the axis of rotation.

13. The connecting apparatus according to claim 12, wherein the first locking element is positioned centrally in the imaginary polygon, and/or wherein the axis of rotation extends through the center of the imaginary polygon.

14. The connecting apparatus according to claim 1, wherein the at least one support element projects beyond a front face of the base body facing the receiving body in a direction of the receiving body and/or wherein the at least one support element is formed separately from the base body and is connected thereto, wherein a sealing element is arranged between the base body and the at least one support element.

15. The connecting apparatus according to claim 1, wherein the at least one abutment element, is integrally connected to the second locking element.

16. The connecting apparatus according to claim 1, wherein the actuating device is manually operable with a handle element that is arranged outside the base body for an operator and that is coupled to a shaft element mounted in the base body so as to be rotatable about a shaft axis.

17. The connecting apparatus according to claim 16, wherein the shaft element is aligned eccentrically with respect to the axis of rotation and/or is arranged in a plane aligned perpendicular to the axis of rotation.

18. The connecting apparatus according to claim 1, wherein the connecting apparatus comprises a transmission device via which the actuating device is operatively connected to the first locking element.

19. The connecting apparatus according to claim 18, wherein the transmission device is or comprises a worm gear that comprises a gear wheel connected in a rotationally fixed manner to the first locking element and a worm element on the actuating device, which worm element is in engagement with the gear wheel.

20. The connecting apparatus according to claim 18, wherein the transmission device is arranged on a side of the base body facing away from the receiving body and is enclosed in a circumferential direction of the axis of rotation by an edge of the base body pointing away from the receiving body.

21. The connecting apparatus according to claim 1, wherein the connecting apparatus comprises or forms a torque limiting device for limiting a torque exerted or exertable on the first locking element by means of the actuating device.

22. The connecting apparatus according to claim 21, wherein the actuating device is manually operable with a handle element that is arranged outside the base body for an operator and that is coupled to a shaft element mounted in the base body so as to be rotatable about a shaft axis, and wherein the handle element and the shaft element are connected to one another via the torque limiting device.

23. The connecting apparatus according to claim 1, wherein a stop element and a corresponding stop element are provided on the base body on the first locking element or in a rotationally fixed connection with the first locking element, by means of which a range of movement of the first locking element is predetermined during rotation relative to the base body.

24. A conveying assembly for conveying conveyed goods, the conveying assembly comprising:
a receiving body for conveyed goods;
a base body having a through-opening;
a drive device for exciting an oscillating movement and/or translatory movement of the base body; and
a connecting apparatus, via which the receiving body is connectable to the base body,
the connecting apparatus comprising:
an abutment device with at least one support element arranged on the base body and at least one abutment element arranged on the receiving body, wherein, in a state of use, the receiving body rests on the at least one support element of the base body via the at least one abutment element;
a locking device with a first locking element arranged on the base body and rotatable about an axis of rotation relative thereto, and a second locking element fixed to the receiving body; and
an actuating device which is operatively connected to the first locking element, wherein by means of the actuating device the first locking element, by rotation about the axis of rotation, is transferrable from a release position, in which the first and second locking elements are disengaged, into a locking position in which the first and second locking elements are in clamping engagement with one another,
the first locking element being guided through a through-opening of the base body and the connecting apparatus comprising a sealing element for sealing the through-opening.

25. The conveying assembly according to claim 24, wherein the receiving body is a conveying pot having a bottom wall and a casing, a rising helix for the conveyed goods being arranged on an inside of the casing.
